(19) United States
(12) Patent Application Publication
(10) Pub. No.: US 2026/0000987 A1
(43) Pub. Date: Jan. 1, 2026

(54) ITEM REPLACEMENT INTERFACE

(71) Applicant: TENCENT TECHNOLOGY (SHENZHEN) COMPANY LIMITED, Shenzhen (CN)

(72) Inventor: Ziyi WANG, Shenzhen (CN)

(73) Assignee: TENCENT TECHNOLOGY (SHENZHEN) COMPANY LIMITED, Shenzhen (CN)

(21) Appl. No.: 19/321,128

(22) Filed: Sep. 5, 2025

Related U.S. Application Data
(63) Continuation of application No. PCT/CN2024/104298, filed on Jul. 8, 2024.

(30) Foreign Application Priority Data
Sep. 5, 2023 (CN) 202311142284.3

(51) Int. Cl. A63F 13/57; A63F 13/53; A63F 13/837

(52) U.S. Cl. CPC A63F 13/57; A63F 13/53; A63F 13/837

(57) ABSTRACT

In a method for processing items in a virtual scene, at least one first item control element is output for display. Each of the at least one first item control element is associated with a pickable virtual item in the virtual scene. At least one second item control element is output for display based on a first trigger operation being performed on a first target item control element. Each of the at least one second item control element is associated with a replaceable virtual item in an inventory of a first virtual object. Based on a second trigger operation being performed on a second target item control element, the replaceable virtual item associated with the second target item control element is removed from the inventory, and the pickable virtual item associated with the first target item control element is added to the inventory.

### RELATED APPLICATIONS

The present application is a continuation of International Application No. PCT/CN2024/104298, filed on Jul. 8, 2024, which claims priority to Chinese Patent Application No. 202311142284.3, filed on Sep. 5, 2023. The entire disclosures of the prior applications are hereby incorporated by reference.

### FIELD OF THE TECHNOLOGY

This application relates to human-computer interaction technologies, including an item processing method in a virtual scenario.

### BACKGROUND OF THE DISCLOSURE

In a display technology based on graphics processing hardware, a channel for sensing an environment and obtaining information is expanded. In a multimedia technology in a virtual scenario, with the help of a human-computer interaction engine technology, diversified interaction between virtual objects controlled by users or artificial intelligence can be implemented based on an actual application requirement. Various typical application scenarios are provided. For example, in a virtual scenario such as a game, a real battle process between virtual objects can be simulated.

A player wins the game by controlling the virtual object to interact in the virtual scenario. During the interaction in the virtual scenario, the virtual object can pick up various items from the virtual scenario to improve diversity and efficiency of the interaction. However, a capacity of an item library of the virtual object is limited. Consequently, in some scenarios, an item in the item library needs to be discarded before a new item is picked up. As a result, an item pickup procedure is complicated, and efficiency of human-computer interaction is limited.

### SUMMARY

Aspects of this disclosure provide an item processing method, an item processing apparatus in a virtual scenario, and a non-transitory computer-readable storage medium, which can improve efficiency of human-computer interaction for item replacement.

Examples of technical solutions of this disclosure may be implemented as follows:

An aspect of this disclosure provides a method for processing items in a virtual scene, at least one first item control element is output for display. Each of the at least one first item control element is associated with a pickable virtual item in the virtual scene. At least one second item control element is output for display based on a first trigger operation being performed on a first target item control element of the at least one first item control element. Each of the at least one second item control element is associated with a replaceable virtual item in an inventory of a first virtual object. Based on a second trigger operation being performed on a second target item control element of the at least one second item control element, the replaceable virtual item associated with the second target item control element is removed from the inventory of the first virtual object, and the pickable virtual item associated with the first target item control element is added to the inventory.

An aspect of this disclosure provides an apparatus for processing items in a virtual scene. The apparatus includes processing circuitry configured to output for display at least one first item control element. Each of the at least one first item control element is associated with a pickable virtual item in the virtual scene. The processing circuitry is configured to output for display at least one second item control element based on a first trigger operation being performed on a first target item control element of the at least one first item control element. Each of the at least one second item control element is associated with a replaceable virtual item in an inventory of a first virtual object. Based on a second trigger operation being performed on a second target item control element of the at least one second item control element, the processing circuitry is configured to remove the replaceable virtual item associated with the second target item control element from the inventory of the first virtual object, and the processing circuitry is configured to add the pickable virtual item associated with the first target item control element to the inventory.

An aspect of this disclosure provides an item processing method in a virtual scenario, the method being performed by an electronic device and including: displaying at least one first item control, each first item control being associated with a to-be-picked-up virtual item in the virtual scenario; displaying at least one second item control in response to a first trigger operation of a first account on a first target item control, the first account being an account controlling a first virtual object, the first target item control being from the at least one first item control, and each second item control being associated with a to-be-replaced virtual item in an item library of the first virtual object; and removing, in response to a second trigger operation of the first account on a second target item control, a to-be-replaced virtual item associated with the second target item control from the item library of the first virtual object, and adding a to-be-picked-up virtual item associated with the first target item control into the item library, the second target item control being from the at least one second item control.

An aspect of this disclosure provides an item processing apparatus in a virtual scenario, the apparatus including: a display module, configured to display at least one first item control, each first item control being associated with a to-be-picked-up virtual item in the virtual scenario; a first trigger module, configured to display at least one second item control in response to a first trigger operation of a first account on a first target item control, the first account being an account controlling a first virtual object, the first target item control being from the at least one first item control, and each second item control being associated with a to-be-replaced virtual item in an item library of the first virtual object; and a second trigger module, configured to: remove, in response to a second trigger operation of the first account on a second target item control, a to-be-replaced virtual item associated with the second target item control from the item library of the first virtual object, and add a to-be-picked-up virtual item associated with the first target item control into the item library, the second target item control being from the at least one second item control.

An aspect of this disclosure provides an electronic device, including: a memory, configured to store computer-executable instructions; and a processor, configured to: implement, when executing the computer-executable instructions stored in the memory, the item processing method in a virtual scenario provided in the aspects of this disclosure.

An aspect of this disclosure provides a non-transitory computer-readable storage medium, having computer-executable instructions stored therein, the computer-executable instructions, when executed by a processor, cause the processor to implement the item processing method in a virtual scenario provided in the aspects of this disclosure.

An aspect of this disclosure provides a computer program product, including computer-executable instructions, the computer-executable instructions, when executed by a processor, implementing the item processing method in a virtual scenario provided in the aspects of this disclosure.

The aspects of this disclosure have the following beneficial effects:

The first target item control is displayed, and the first target item control is associated with the to-be-picked-up virtual item. In response to the first trigger operation on the first target item control, the second item control is displayed. The second item control is associated with the to-be-replaced virtual item in the item library of the first virtual object. This is equivalent to that a control of an item for replacement can be presented through triggering of a control of a to-be-picked-up item, reducing an interaction operation of opening the item library. In response to the second trigger operation on the second target item control, the to-be-replaced virtual item in the item library is replaced with the to-be-picked-up virtual item. This is equivalent to that an operation of picking up a new item and an operation of discarding an old item are completed together, further reducing an interaction procedure and improving overall efficiency of human-computer interaction.

### BRIEF DESCRIPTION OF THE DRAWINGS

FIG. 1A to FIG. 1D are schematic interface diagrams of an item processing method according to an aspect of this disclosure.

FIG. 2A and FIG. 2B are schematic architectural diagrams of an item processing system according to an aspect of this disclosure.

FIG. 3 is a schematic structural diagram of an electronic device according to an aspect of this disclosure.

FIG. 4A to FIG. 4C are schematic flowcharts of an item processing method according to an aspect of this disclosure.

FIG. 5A to FIG. 5E are schematic interface diagrams of an item processing method according to an aspect of this disclosure.

FIG. 6A to FIG. 6C are schematic interaction diagrams of an item processing method according to an aspect of this disclosure.

FIG. 7A to FIG. 7C are schematic logic diagrams of an item processing method according to an aspect of this disclosure.

### DETAILED DESCRIPTION

To make the objectives, technical solutions, and advantages of this disclosure clearer, the following describes this disclosure in further detail with reference to the accompanying drawings. The aspects described are not to be considered as a limitation to this disclosure. Other aspects are within the scope of this disclosure. The descriptions of the terms are provided as examples only and are not intended to limit the scope of the disclosure.

In the following descriptions, related “some aspects” describe a subset of all possible aspects. However, the “some aspects” may be the same subset or different subsets of all the possible aspects, and may be combined with each other without conflict.

In the following descriptions, the included term “first/second/third” is merely intended to distinguish similar objects but does not necessarily indicate specific order of an object. “First/second/third” is interchangeable in terms of a specific order or sequence if permitted, so that the aspects of this disclosure described herein can be implemented in a sequence in addition to the sequence shown or described herein.

Unless otherwise defined, meanings of all technical and scientific terms used in this specification are the same as those usually understood by a person skilled in the art to which this disclosure belongs. Terms used in this specification are merely intended to describe objectives of the aspects of this disclosure, but are not intended to limit this disclosure.

Before the aspects of this disclosure are further described in detail, nouns and terms involved in the aspects of this disclosure are described. The nouns and terms provided in the aspects of this disclosure are applicable to the following explanations.

(1) Virtual scenario: It is a scenario that is outputted by a device and is different from a reality world. Visual perception for the virtual scenario can be formed with the aid of naked eyes or devices. For example, a two-dimensional image is outputted by using a display screen, or a three-dimensional image is outputted by using a three-dimensional display technology such as three-dimensional projection, virtual reality, or augmented reality. In addition, a variety of perception simulating the real world such as auditory perception, tactile perception, olfactory perception, and motion perception can be alternatively formed by using a variety of possible hardware.

(2) In response to: It is configured for representing a condition or status on which one or more operations to be performed depend. When the condition or status is satisfied, the one or more operations may be performed in real time or after a set delay. Unless explicitly stated, there is no limitation on an order in which the plurality of operations are performed.

(3) Virtual object: It is an object that performs interaction in a virtual scenario, and is an object being controlled by a user or a robot program (for example, a robot program based on artificial intelligence) and being capable of being stable, moving, and performing various behaviors in the virtual scenario. For example, the virtual object is each role in a game.

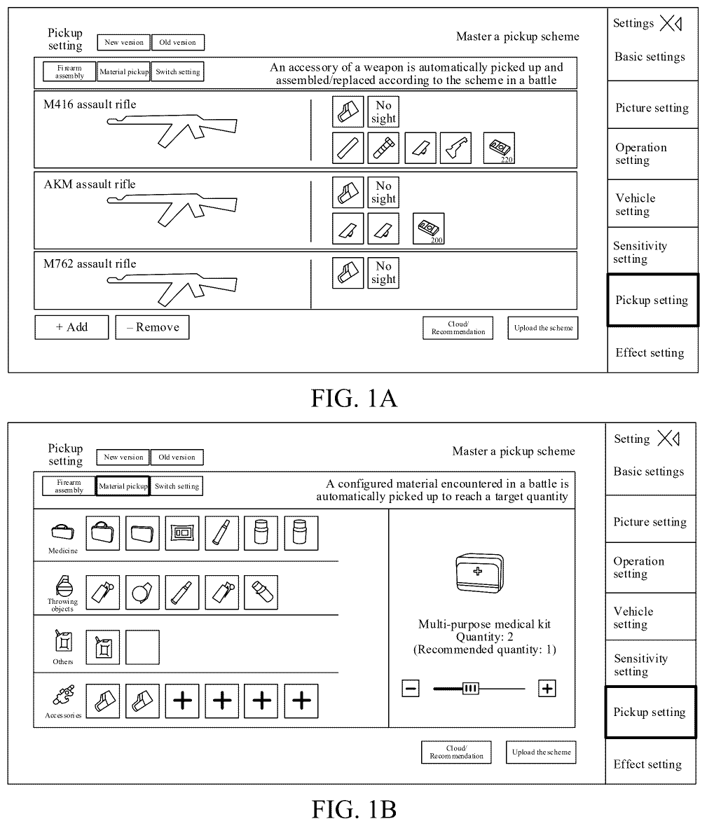

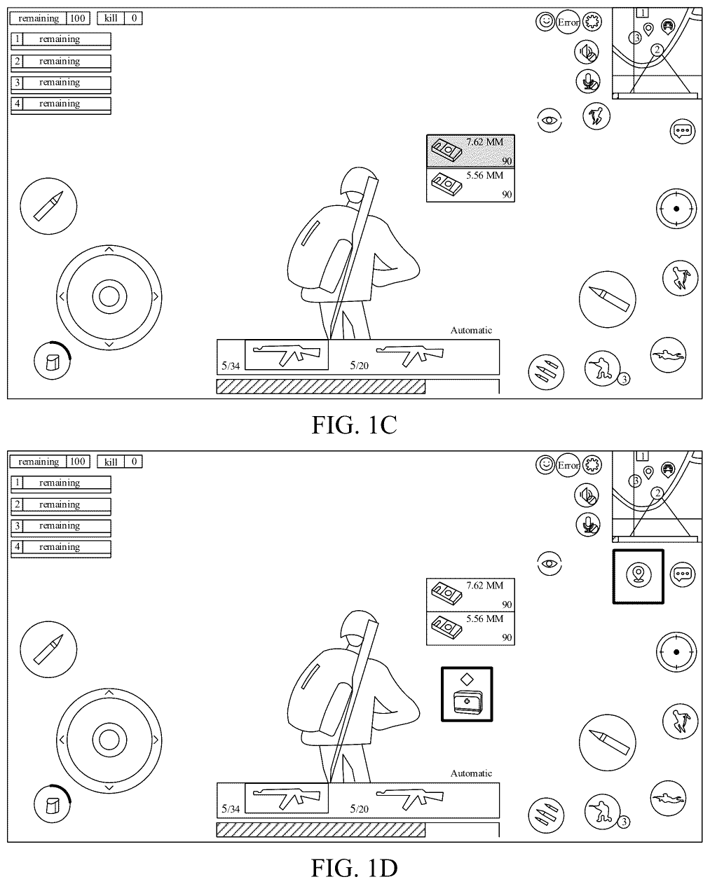

(4) Optimal match: Referring to FIG. 1A, a player can preset an optimal match of in-game materials on a setting interface. The optimal match herein refers to an optimal accessory for each shooting item, an optimal pickup quantity for each medicine and throwing object, and the like.

(5) Recommended material: Referring to FIG. 1B, when a player picks up a material in a game, if the material satisfies an optimal match of a user, a bottom color of the material turns yellow. The material displayed in yellow herein is the recommended material.

A user in a game may set, based on a requirement, priorities of materials and shooting item accessories that are needed in the game on a setting interface outside the game. For example, an M4 holographic sight is an optimal solution, an AK red dot sight is an optimal solution, two medical kits need to be picked up, or ten bandages need to be picked up. When picking up a material, if there is space in a backpack, a recommended material is automatically picked up into the backpack. An interaction process of an entire procedure is very simple.

In related art, a virtual item is placed in various locations, and a player cannot always pick up an optimal material, but for safety, the player often picks up whatever in sight until an entire backpack is filled. Eventually, when there is a recommended material in sight, the recommended material is not automatically picked up because a capacity of the backpack is full, and the player further needs to open the backpack to discard an existing material and then pick up the recommended material. The entire procedure is very complicated and time-consuming. Referring to FIG. 1C, when the player participates in a battle in a virtual scenario, if there is still space in the backpack, when the player is close to a recommended material, a system automatically picks up the material and put the material into the backpack of the player. Referring to FIG. 1D, when a crosshair of the player is aimed at a material in the virtual scenario, by triggering a “mark” button is triggered, the material is marked, so that all teammates can see the material.

In the related art, currently, an automatic pickup function only takes effect when the backpack still has a capacity. However, the recommended material is encountered when the capacity of the backpack is full. As a result, the player further needs to open the backpack to discard a useless material and then close the backpack, and many human-computer interaction operations are performed. In addition, because each player has a different demand for materials and material is placed in various locations, there may be a case in which a material discarded by a player A may be a recommended material needed by a player B. In this case, the player A often needs to move a crosshair to the recommended material in the virtual scenario and mark the recommended material through clicking/tapping, so that other teammates can receive marking information. Because a hot area of the recommended material is too small, the marking needs to be very precise. In an actual game, for convenience, players rarely perform alignment marking, resulting in a waste of many resources.

The aspects of this disclosure provides an item processing method and apparatus in a virtual scenario, an electronic device, a computer-readable storage medium, and a computer program product, which can improve efficiency of human-computer interaction for item replacement. Example applications of the electronic device provided in the aspects of this disclosure are described below. The electronic device provided in the aspects of this disclosure may be implemented as each type of user terminal such as a notebook computer, a tablet computer, a desktop computer, a set-top box, or a mobile device (for example, a mobile phone, a portable music player, a personal digital assistant, a dedicated messaging device, or a portable game device).

To facilitate easier understanding of the item processing method in a virtual scenario provided in the aspects of this disclosure, an example implementation scenario of the item processing method in a virtual scenario provided in the aspects of this disclosure is first described. The virtual scenario may be outputted based on a terminal, or may be outputted based on cooperation of a terminal and a server.

In some aspects, the virtual scenario may be an environment provided for interaction of game characters. For example, the virtual scenario may be an environment provided for game characters to join a battle. By controlling actions of virtual objects, both parties may interact in the virtual scenario.

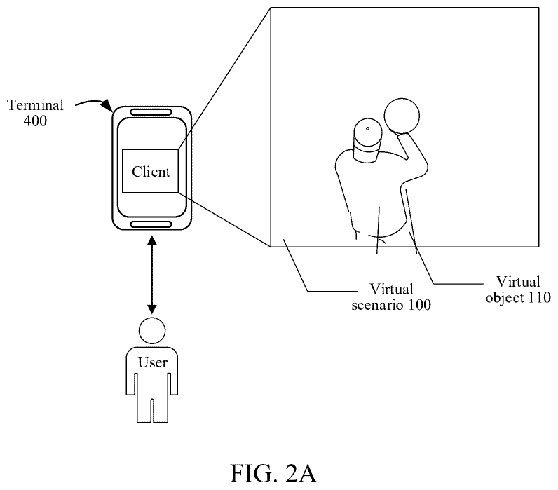

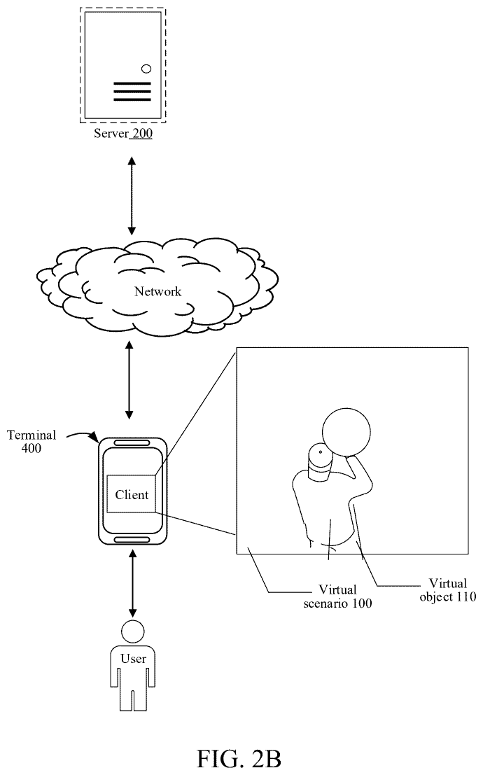

In an implementation scenario, FIG. 2A is a schematic diagram of an application mode of an item processing method in a virtual scenario according to an aspect of this disclosure, and is applicable to some application modes in which calculation of related data of a virtual scenario 100 can be completed totally depending on a calculation capability of a terminal 400. For example, in a stand-alone/offline game, output of the virtual scenario is completed through the terminal 400 such as a smartphone, a tablet computer, or a virtual reality/augmented reality device.

When visual perception of the virtual scenario 100 (including a virtual object 110) is formed, the terminal 400 calculates, by using graphics calculation hardware, data needed for display, and completes uploading, parsing, and rendering of displayed data. A video frame that can forms visual perception for the virtual scenario is outputted on graphics output hardware. For example, a two-dimensional video frame is displayed on a display screen of a smartphone, or a video frame is projected on lenses of augmented reality/virtual reality glasses to achieve a three-dimensional display effect. In addition, to enrich a perception effect, a device may alternatively use different hardware to form one or more of auditory perception, tactile perception, motion perception, and taste perception.

In an example, the terminal 400 runs a client (for example, a stand-alone gaming application). During the running of the client, a virtual scenario including role playing is outputted. The virtual scenario is an environment provided for interaction of game characters. For example, the virtual scenario may be a plain, a street, a valley, or the like that is provided for game characters to join a battle. At least one first item control is displayed on the terminal 400. Each first item control is associated with a to-be-picked-up virtual item in the virtual scenario. At least one second item control is displayed in response to a first trigger operation of a first account on a first target item control. The first account is an account controlling a first virtual object, the first target item control is from the at least one first item control, and each second item control is associated with a to-be-replaced virtual item in an item library of the first virtual object. In response to a second trigger operation of the first account on a second target item control, a to-be-replaced virtual item associated with the second target item control is removed from the item library of the first virtual object, and a to-be-picked-up virtual item associated with the first target item control is added into the item library. The terminal 400 may be a terminal used by a player controlling the first virtual object or a terminal run by an AI program controlling the first virtual object.

In another implementation scenario, FIG. 2B is a schematic diagram of an application mode of an item processing method in a virtual scenario according to an aspect of this disclosure, and is applied to a terminal 400 and a server 200, and is applicable to an application mode in which calculation of the virtual scenario is completed depending on a calculation capability of the server 200 and the virtual scenario is outputted at the terminal 400.

Forming visual perception of a virtual scenario 100 (including a virtual object 110) is used as an example, the server 200 performs calculation of display data related with the virtual scenario and transmits calculated data to the terminal 400. The terminal 400 completes, depending on graphics calculation hardware, uploading, parsing, and rendering of the calculated display data, and outputs, depending on graphics output hardware, the virtual scenario, to form the visual perception. For example, a two-dimensional video frame may be displayed on a display screen of a smartphone, or a video frame may be projected on lenses of augmented reality/virtual reality glasses to achieve a three-dimensional display effect. For perception in a form of the virtual scenario, related hardware of the terminal may be used for output, for example, microphone output is used to form auditory perception, and vibrator output is used to form tactile perception.

In an example, the terminal 400 runs a client (for example, a network-version gaming application). Gaming interaction with another user is performed through a connection to a game server (namely, the server 200). At least one first item control is displayed on the terminal 400. Each first item control is associated with a to-be-picked-up virtual item in the virtual scenario. The terminal 400 transmits, in response to a first trigger operation of a first account on a first target item control, operation data of the first trigger operation to the server 200. The server 200 obtains display data of an operation result, and returns the display data to the terminal 400. At least one second item control is displayed on a human-computer interaction interface of the terminal 400. The first target item control is from the at least one first item control, and each second item control is associated with a to-be-replaced virtual item in an item library of a first virtual object. The terminal 400 transmits, in response to a second trigger operation of the first account on a second target item control, operation data of the second trigger operation to the server 200. The server 200 obtains display data of an operation result, and returns the display data to the terminal 400. A to-be-replaced virtual item associated with the second target item control is removed from the item library of the first virtual object, and a to-be-picked-up virtual item associated with the first target item control is added into the item library. The terminal 400 may be a terminal used by a player controlling the first virtual object or a terminal run by an AI program controlling the first virtual object.

In some aspects, the terminal 400 may implement, by running a computer program, the item processing method in a virtual scenario provided in the aspects of this disclosure. For example, the computer program may be a native program or a software module in an operating system; may be a native application (APP), namely, a program that needs to be installed in an operating system to run, for example, a gaming APP (namely, the foregoing client); or may be an applet, namely, a program that only needs to be downloaded into a browser environment to run; or may be a gaming applet that can be embedded into any APP. In conclusion, the foregoing computer program may be any form of an application, a module, or a plug-in.

The aspects of this disclosure may be implemented through a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on application of a cloud computing business mode, and may form a resource pool, which is used as required, and is flexible and convenient. A cloud computing technology becomes an important support. A background service of a technical network system requires a large amount of computing and storage resources.

In an example, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, or the like, but is not limited thereto. The terminal 400 and the server 200 may be directly or indirectly connected in a wired or wireless communication manner. This is not limited in the aspects of this disclosure.

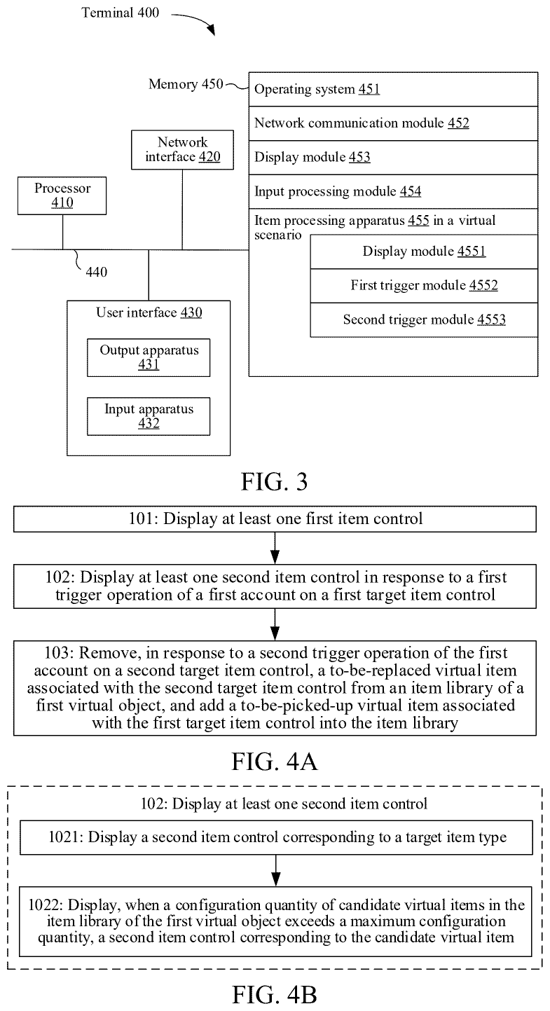

FIG. 3 is a schematic structural diagram of an electronic device to which an item processing method in a virtual scenario is applied according to an aspect of this disclosure. An example in which the electronic device is a terminal is used for description. A terminal 400 shown in FIG. 3 includes: at least one processor 410 (for example, processing circuitry), a memory 450 (for example, a non-transitory computer-readable storage medium), at least one network interface 420, and a user interface 430. All the components in the terminal 400 are coupled together by a bus system 440. The bus system 440 is configured to implement connection and communication between the components. In addition to a data bus, the bus system 440 further includes a power bus, a control bus, and a state signal bus. However, for clear description, all types of buses in FIG. 3 are marked as the bus system 440.

The processor 410 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any other processor, or the like.

The user interface 430 includes one or more output apparatuses 431 that can display media content, including one or more loudspeakers and/or one or more visual display screens. The user interface 430 further includes one or more input apparatuses 432, including user interface components that facilitate inputting of a user, such as a keyboard, a mouse, a microphone, a touch display screen, a camera, and another input button and control.

The memory 450 may be a removable memory, a non-removable memory, or a combination thereof. Example hardware devices include a solid-state memory, a hard disk drive, an optical disc driver, and the like. The memory 450, in some aspects, includes one or more storage devices physically away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this aspect of this disclosure is to include any suitable type of memories.

In some aspects, the memory 450 can store data to support various operations. Examples of the data include a program, a module, and a data structure, or a subset or a superset thereof, which are described below by using examples.

An operating system 451 includes a system program configured to process various basic system services and perform a hardware-related task, such as a framework layer, a core library layer, or a driver layer, and is configured to implement various basic services and process a hardware-based task.

A network communication module 452 is configured to reach another electronic device through one or more (wired or wireless) network interfaces 420. Example network interfaces 420 include: a Bluetooth interface, a Wi-Fi interface, a universal serial bus (USB), and the like.

A display module 453 is configured to display information by using an output apparatus 431 (for example, a display screen or a speaker) associated with one or more user interfaces 430 (for example, a user interface configured to operate a peripheral device and display content and information).

An input processing module 454 is configured to detect one or more user inputs or interactions from one of the one or more input apparatuses 432 and translate the detected input or interaction.

In some aspects, the item processing apparatus in a virtual scenario provided in the aspects of this disclosure may be implemented by using software. FIG. 3 shows an item processing apparatus 455 in a virtual scenario stored in the memory 450. The apparatus 455 may be software in a form such as a program and a plug-in, and includes the following software modules: a display module 4551, a first trigger module 4552, and a second trigger module 4553. The modules are logical modules, and may be combined in various manners or further divided based on a function to be achieved. A function of each module is to be described below.

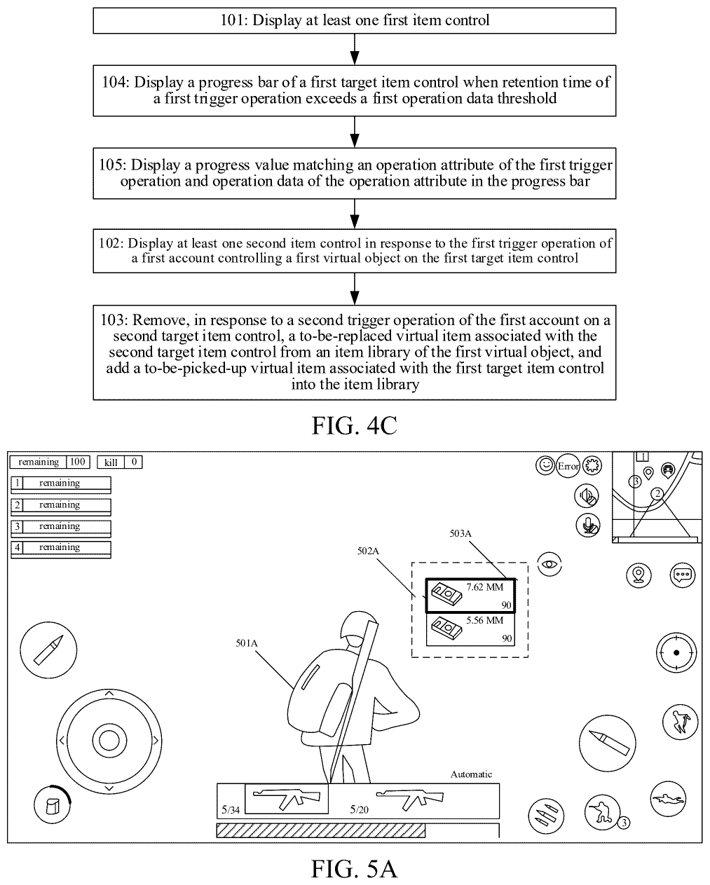

FIG. 4A is a schematic flowchart of an item processing method in a virtual scenario according to an aspect of this disclosure. Description is provided below with reference to operations shown in FIG. 4A.

The method shown in FIG. 4A may be performed by various forms of computer programs run by a terminal, and is not limited to the foregoing client, for example, the operating system above, the software module, or a script. Therefore, the client is not to be considered as a limitation to the aspects of this disclosure.

Operation 101: Display at least one first item control. For example, at least one first item control element is output for display. Each of the at least one first item control element is associated with a pickable virtual item in the virtual scene.

In an example, each first item control is associated with a to-be-picked-up virtual item in the virtual scenario. Various to-be-picked-up virtual items are scattered around in the virtual scenario. To facilitate picking up of the virtual item, an item control associated with the virtual item may be displayed. In response to a trigger operation on the item control, the virtual item associated with the item control can be picked up.

In some aspects, the displaying at least one first item control in Operation 101 may be implemented through the following technical solutions: displaying, when a first distance between a first virtual object and the to-be-picked-up virtual item is less than a first distance threshold, a first item control associated with the to-be-picked-up virtual item.

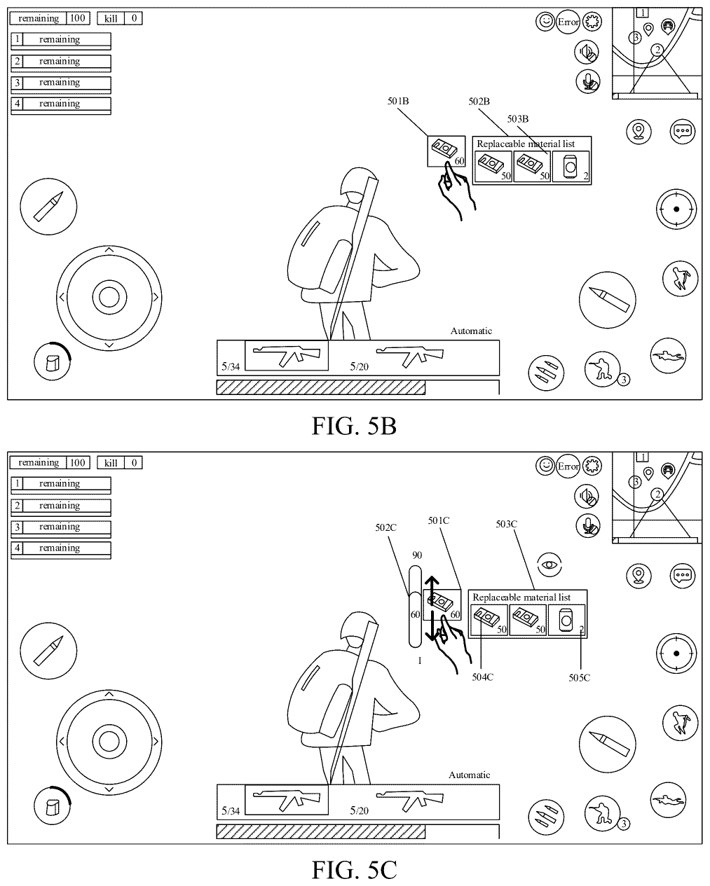

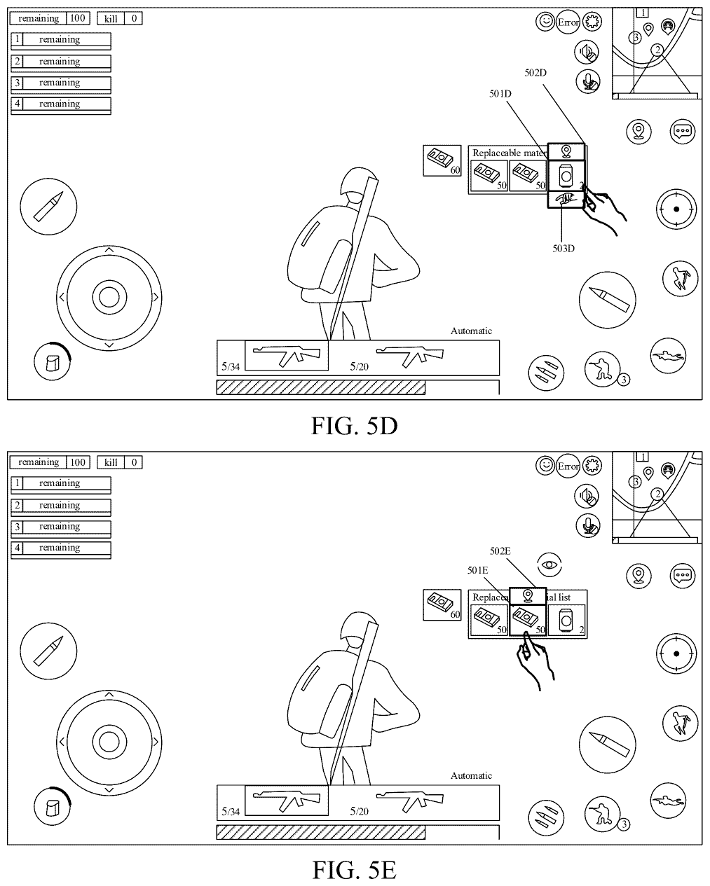

In an example, referring to FIG. 5A, when a first virtual object 501A controlled by a first account is close to a first virtual item, a pickup list 502A is displayed on a human-computer interaction interface. The pickup list 502A includes at least one first item control, for example, a first item control 503A. That the first virtual object is close to the first virtual item herein may be that a first distance between the first virtual object and the first virtual item is less than the first distance threshold. Through the aspects of this disclosure, only an item control of a virtual item within a pickup range can be displayed, thereby improving display resource utilization.

Operation 102: Display at least one second item control in response to a first trigger operation of the first account on a first target item control. The first account is an account controlling the first virtual object, the first target item control is from the at least one first item control, and each second item control is associated with a to-be-replaced virtual item in an item library of the first virtual object. For example, at least one second item control element is output for display based on a first trigger operation being performed on a first target item control element of the at least one first item control element. Each of the at least one second item control element is associated with a replaceable virtual item in an inventory of a first virtual object.

In this aspect of this disclosure, the first target item control is displayed, and the first target item control is associated with a to-be-picked-up virtual item. In response to the first trigger operation on the first target item control, the second item control is displayed. The second item control is associated with the to-be-replaced virtual item in the item library of the first virtual object. This is equivalent to that a control of an item for replacement can be presented through triggering of a control of a to-be-picked-up item, reducing an interaction operation of opening the item library. In response to the second trigger operation on the second target item control, the to-be-replaced virtual item in the item library is replaced with the to-be-picked-up virtual item. This is equivalent to that an operation of picking up a new item and an operation of discarding an old item are completed together, further reducing an interaction procedure and improving overall efficiency of human-computer interaction.

In some aspects, the displaying at least one second item control in Operation 102 may be implemented through the following technical solutions: displaying the at least one second item control when the first trigger operation is any trigger operation and a capacity occupied by all virtual items of the first virtual object exceeds a capacity threshold; or displaying the at least one second item control when operation attribute data of the first trigger operation satisfies a trigger condition of item replacement logic.

In an example, the operation attribute data may be contact pressure of the trigger operation or contact time of the trigger operation. Herein the first trigger operation on the first target item control may be a special operation such as a press operation with contact pressure exceeding a pressure threshold or a long-press operation with contact time exceeding a first time threshold. When the contact pressure exceeds the pressure threshold, or the contact time exceeds the first time threshold, the trigger condition of the item replacement logic is satisfied. Through the special operations, a replacement function can be activated, that is, the at least one second item control can be displayed. When the capacity occupied by all virtual items of the first virtual object exceeds the capacity threshold (for example, a capacity of the item library owned by the first virtual object has been fully occupied), the first trigger operation herein may be any trigger operation on the first target item control, for example, may be a regular trigger operation such as a clicking/tapping operation. A more flexible interaction manner may be provided through the aspects of this disclosure. The replacement function may be actively activated through the special operation, or may be activated through an ordinary pickup operation in a case that the capacity is largely occupied.

In some aspects, when a plurality of first item controls exist, when the at least one second item control is displayed, a first item control other than the first target item control in the plurality of displayed first item controls is hidden.

In an example, referring to FIG. 5B, the pickup list itself displays the first item controls corresponding to all the first virtual items near the first virtual object. When the at least one second item control is displayed, it indicates that the player is in a material replacement state. In this case, the pickup list is hidden, and only a first target item control 501B is retained. Through the aspects of this disclosure, a to-be-picked-up virtual item and replaceable virtual items can be presented to the player, thereby improving display resource utilization.

Operation 103: Remove, in response to a second trigger operation of the first account on a second target item control, a to-be-replaced virtual item associated with the second target item control from the item library of the first virtual object, and add the to-be-picked-up virtual item associated with the first target item control into the item library. The second target item control is from the at least one second item control. For example, based on a second trigger operation being performed on a second target item control element of the at least one second item control element, the replaceable virtual item associated with the second target item control element is removed from the inventory of the first virtual object, and the pickable virtual item associated with the first target item control element is added to the inventory.

In some aspects, referring to FIG. 4B, the displaying at least one second item control in Operation 102 may be implemented through at least one of Operation 1021 and Operation 1022 shown in FIG. 4B.

Operation 1021: Display a second item control corresponding to a target item type. The target item type is an item type corresponding to the first target item control. For example, a second item control element corresponding to a target item type is output for display. The target item type corresponds to an item type of the first target item control element.

Through the aspects of this disclosure, an item type corresponding to the second item control can be controlled to be the same as an item type of a to-be-picked-up virtual item selected through the first trigger operation. In other words, replacement within the same item type can be implemented, so that there is no need to display second item controls of all to-be-replaced virtual items. Therefore, time of a user in performing selection from a large amount of items can be reduced, and efficiency of human-computer interaction can be improved.

In some aspects, the displaying a second item control corresponding to a target item type in Operation 1021 may be implemented through the following technical solutions: displaying the second item control corresponding to the target item type when the target item type is an attack item type and the first virtual object has been equipped with a virtual item of the target item type.

In an example, the second item control displayed in Operation 102 and the first target item control are correspondingly in a same item type. For example, if a virtual item corresponding to the first target item control is a shooting item, a to-be-replaced virtual item associated with the second item control is also a shooting item. The shooting item herein belongs to the attack item type. If the first virtual object has been equipped with a virtual item belonging to the attack item type, a second item control associated with the virtual item belonging to the attack item type is displayed. If the first virtual object is not equipped with a virtual item belonging to the attack item type, a second item control associated with the virtual item belonging to the attack item type is not displayed. Through the aspects of this disclosure, in a case that the first virtual object has been equipped with a virtual item of the attack item type, a second item control of the attack item type is displayed, so that item replacement in the attack item type can be implemented, there is no need to perform replacement and selection among a large amount of items during interaction using the attack item, and efficiency of human-computer interaction is improved.

In some aspects, the displaying a second item control corresponding to a target item type in Operation 1021 may be implemented through the following technical solutions: displaying, when the target item type is an accessory item type and a quantity of virtual items belonging to the accessory item type in the item library is less than a first quantity threshold, second item controls corresponding to all virtual items belonging to the accessory item type; and displaying, when the target item type is the accessory item type and the quantity of virtual items belonging to the accessory item type in the item library is not less than the first quantity threshold, a second item control corresponding to a virtual item that belongs to the accessory item type and that is related with equipment of the first virtual object.

In an example, the second item control displayed in Operation 102 and the first target item control are in a same item type. For example, if a virtual item corresponding to the first target item control is a stock accessory, a to-be-replaced virtual item associated with the second item control may be a sight accessory. The stock accessory and the sight accessory herein both belong to the accessory item type. If the quantity of virtual items belonging to the accessory item type in the item library is less than the first quantity threshold, for example, if the quantity of virtual items belonging to the accessory item type in the item library is less than 3, all accessories are displayed in a replaceable material list, that is, second item controls corresponding to all virtual items belonging to the accessory item type are displayed. If the quantity of virtual items belonging to the accessory item type in the item library is not less than 3, an accessory on a shooting item (equipment of the first virtual object) is displayed in the replaceable material list, that is, a second item control corresponding to a virtual item that belongs to the accessory item type and that is related with the equipment is displayed. Through aspects of this disclosure, display resources can be effectively used. When the quantity of virtual items belonging to the accessory item type is small, all the display resources can be displayed. If the quantity of virtual items belonging to the accessory item type is large, a part of the display resources related with the equipment is displayed. This can maintain diversity of the virtual items in the item library, and help to improve a use rate of different types of virtual items.

In some aspects, the displaying a second item control corresponding to a target item type in Operation 1021 may be implemented through the following technical solutions: displaying, when the target item type is an item type in another item type and a quantity of virtual items belonging to the another item type in the item library is less than a second quantity threshold, second item controls corresponding to all virtual items belonging to the another item type; and displaying, when the target item type is the another item type and the quantity of virtual items belonging to the another item type in the item library is not less than the second quantity threshold, a second item control corresponding to a virtual item belonging to the target item type, the another item type being an item type other than an attack item type and an accessory item type.

In an example, the second item control displayed in Operation 102 and the first target item control are in a same item type. The another item type herein includes ammunition, medicine, or a throwing object. For example, if a virtual item corresponding to the first target item control is rifle ammunition, a to-be-replaced virtual item associated with the second item control may be handgun ammunition. The rifle ammunition and the handgun ammunition herein both belong to the another item type. If the quantity of virtual items belonging to the another item type in the item library is less than the second quantity threshold, for example, if the quantity of virtual items belonging to the another item type in the item library is less than 6, second item controls of all virtual items belonging to the another item type are displayed in the replaceable material list. If the quantity of virtual items belonging to the another item type in the item library is not less than 6, materials of a same type are displayed, that is, a second item control corresponding to a virtual item belonging to the target item type is displayed. Through the aspects of this disclosure, display resources can be effectively used. When the quantity of virtual items belonging to the another item type is small, all the display resources can be displayed. If the quantity of virtual items belonging to the another item type is large, only the virtual item belonging to the target item type is displayed. This is equivalent to that item replacement of a same type can be quickly implemented, and efficiency of human-computer interaction can be improved.

Operation 1022: Display, when a configuration quantity of candidate virtual items in the item library of the first virtual object exceeds a maximum configuration quantity, a second item control corresponding to the candidate virtual item. The maximum configuration quantity is a maximum holding quantity of each type of virtual item in a target item configuration of the item library.

In an example, the technical solution of Operation 1021 is to associate the second item control with the first item control, in other words, virtual items associated with the first item control and the second item control belong to the same item type. A focus of Operation 1022 is quantitative balance of the virtual items in the item library, in other words, when the configuration quantity of candidate virtual items exceeds an optimal match quantity configured outside the game (which can also be understood as a preset maximum configuration quantity), the candidate virtual item is replaced, so that the second item control associated with the candidate virtual item is displayed. Through the aspects of this disclosure, the quantitative balance of the virtual items in the item library can be controlled. This can improve the diversity of virtual items in the item library, and help to improve the use rate of different types of virtual items.

In some aspects, referring to FIG. 4C, the first trigger operation is a continuous operation on a target connection button. After Operation 101 is performed, Operation 104 and Operation 105 shown in FIG. 4C can be performed.

Operation 104: Display a progress bar of the first target item control when retention time of the first trigger operation exceeds a first operation data threshold. A progress value of the progress bar represents a pickup quantity of to-be-picked-up virtual items corresponding to the first target item control. For example, a progress bar of the first target item control element is output for display when a retention time of the first trigger operation exceeds a first time threshold. A progress value of the progress bar changes according to a pickup quantity of the pickable virtual item associated with the first target item control element.

Operation 105: Display a progress value matching an operation attribute of the first trigger operation and operation data of the operation attribute in the progress bar.

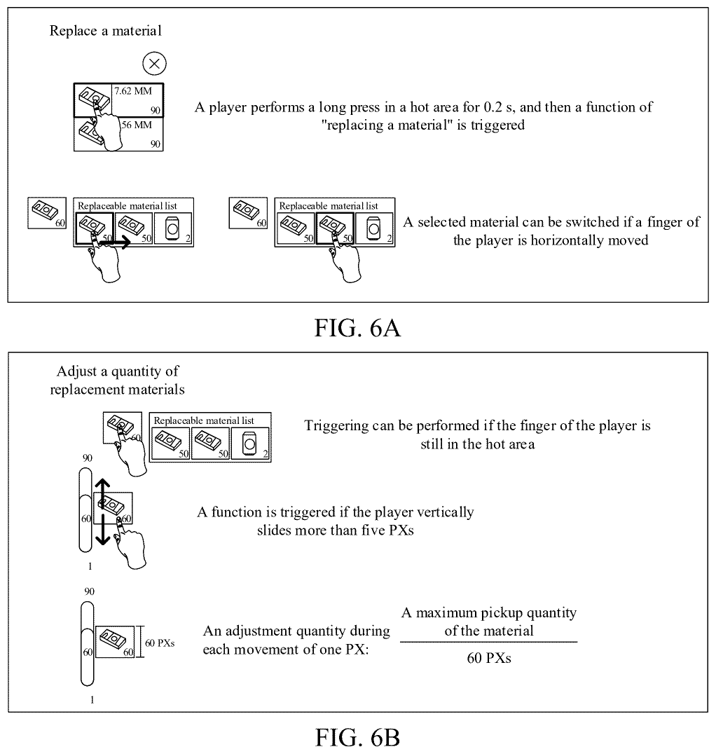

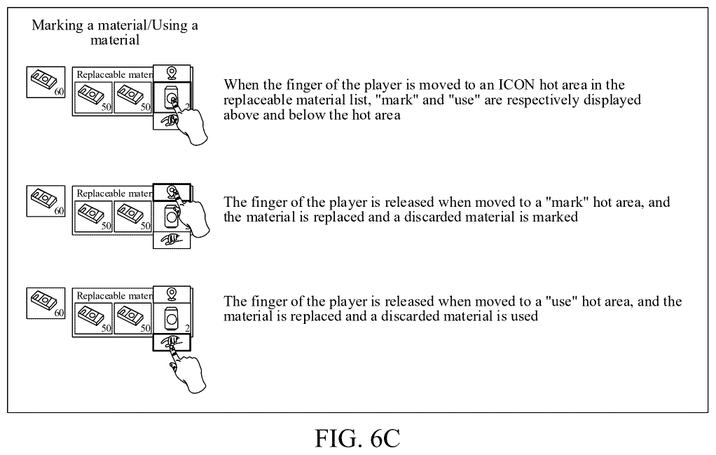

In an example, referring to FIG. 5C and FIG. 6B, after the player moves up and down more than five pixels in a hot area of a long-pressed control 501C (the first target item control), a progress bar 502C about a pickup quantity may be displayed on a left side of the long-pressed control 501C. A height of the progress bar can be controlled by sliding a screen up and down. A higher progress bar indicates a higher pickup quantity, and a lower progress bar indicates a lower pickup quantity. Through the aspects of this disclosure, a pickup quantity of to-be-picked-up virtual items can be represented in a visualization manner. In addition, the first trigger operation is reused, to determine the pickup quantity, so that the efficiency of human-computer interaction can be effectively improved.

In some aspects, when the at least one second item control is displayed in Operation 102, a quantity of to-be-replaced virtual items associated with each second item control in the item library may be further displayed; and when the progress value matching the operation attribute of the first trigger operation and the operation data of the operation attribute is displayed in the progress bar, based on the progress value, the displayed quantity of to-be-replaced virtual items associated with each second item control in the item library is updated.

In some aspects, when the at least one second item control is displayed in Operation 102, a virtual item identifier of the to-be-replaced virtual item associated with each second item control in the item library may be further displayed.

In an example, the virtual item identifier and the quantity herein may be displayed on the associated second item control in a superposition manner, or may be displayed at a nearby location of the associated second item control. The nearby location herein is a location where a distance from the second item control is less than a distance threshold.

In an example, referring to FIG. 5C, an identifier 504C of the to-be-replaced virtual item associated with each second item control is displayed, and a quantity 505C of to-be-replaced virtual items associated with each second item control in the item library is displayed. When the progress value matching the operation attribute of the first trigger operation and the operation data of the operation attribute is displayed in the progress bar, that is, when a quantity of picked-up items is displayed in the progress bar 502C, a quantity of to-be-replaced items is simultaneously displayed. In other words, a quantity of materials for replacement in a replaceable material list 503C on a right side of the long-pressed control 501C (the first target item control) is also correspondingly changed. The quantity herein is a quantity of replaceable materials. Through the aspects of this disclosure, the quantity of to-be-replaced virtual items can be shown in a visualization manner. In addition, the first trigger operation is reused, to determine the quantity of to-be-replaced virtual items, so that the efficiency of human-computer interaction can be effectively improved.

In some aspects, after the at least one second item control is displayed, when the first trigger operation is a continuous operation and is not released during the displaying of the second item control, a movement track is generated in response to the continuous operation, and the second target item control is displayed in a selected state when a contact point of the continuous operation is moved to a sensing area corresponding to the second target item control; and when the continuous operation is released, the releasing of the continuous operation is identified as the second trigger operation on the second target item control.

In an example, the first trigger operation and the second trigger operation herein may be sub-operations in a set of continuous operations. For example, a long press operation (contact time exceeding the first time threshold) on the first target item control is the first trigger operation, and an operation that moves the contact point from the first target item control to the second target item control and that is released after the movement to the second target item control is the second trigger operation. Through the aspects of this disclosure, a human-computer interaction operation of an entire replacement procedure can be simplified into a one-time interaction operation, thereby improving the efficiency of human-computer interaction.

In some aspects, after the second target item control is displayed in the selected state, a use control and a mark control are displayed at corresponding locations of the second target item control when the to-be-replaced virtual item associated with the second target item control is a markable and usable item; or a mark control is displayed at a corresponding location of the second target item control when the to-be-replaced virtual item associated with the second target item control is a markable and unusable item.

In an example, the corresponding location of the second target item control herein is a location where a distance from the second target item control is less than a distance threshold. The distance herein may be zero, that is, the mark control or the use control is displayed at a location of the second target item control.

In an example, when the material replacement state is entered, whether a finger of the player is moved to a hot area of a control (the first target item control) at the replaceable material list needs to be determined. If the finger is not moved to the hot area, there is no change. If the finger is moved to the hot area, a type of a to-be-replaced virtual item (the to-be-picked-up virtual item associated with the first target item control) selected by the first account needs to be further determined. If the to-be-replaced virtual item is attack equipment, equipment, an accessory, ammunition, or the like, a mark button (the mark control) is displayed above the selected control (the second target item control). If the to-be-replaced virtual item is medicine or a throwing object, a mark button (the mark control) is displayed above the selected control, and a use button (the use control) is displayed below the selected control. Through the aspects of this disclosure, for virtual items in different states, controls conforming to the corresponding states can be displayed at corresponding locations of corresponding second target item controls. Through differentiation of control display, the efficiency of human-computer interaction can be improved.

In some aspects, when the contact point of the continuous operation is moved to the mark control, releasing of the continuous operation at the mark control is identified as the second trigger operation on the second target item control, and the to-be-replaced virtual item associated with the second target item control is marked, to prompt a second virtual object located in a same group as the first virtual object to pick up the marked virtual item; or when the contact point of the continuous operation is moved to the use control, releasing of the continuous operation at the use control is identified as the second trigger operation on the second target item control, and a process in which the first virtual object uses the to-be-replaced virtual item associated with the second target item control is displayed.

In an example, if the to-be-replaced virtual item is attack equipment, equipment, an accessory, or ammunition, the mark control is displayed above the selected second target item control. If the to-be-replaced virtual item is medicine or a throwing object, the mark control is displayed above the selected second target item control, and the use control is displayed below the selected second target item control. In this case, whether the contact point of the continuous operation of the player is moved to the mark control needs to be determined. If the contact point of the continuous operation of the player is not moved to the mark control, there is no change. If the contact point of the continuous operation of the player is moved to the mark control, the mark control is selected, and whether the player releases the finger (whether the continuous operation is released) needs to be determined again. If the player does not release the finger, there is no change. If the player releases the finger, a corresponding quantity of to-be-picked-up virtual items associated with the first target item control are picked up, a corresponding quantity of to-be-replaced virtual items associated with the second target item control are discarded, and the to-be-replaced virtual items associated with the second target item control are automatically marked. In this case, whether the contact point of the continuous operation of the player is moved to the use control needs to be determined. If the contact point of the continuous operation of the player is not moved to the use control, there is no change. If the contact point of the continuous operation of the player is moved to the use control, the use control is selected, and whether the player releases the finger (whether the continuous operation is released) needs to be determined again. If the player does not release the finger, there is no change. If the player releases the finger, a corresponding quantity of to-be-picked-up virtual items associated with the first target item control are picked up, a quantity of to-be-replaced virtual items associated with the second target item control are discarded, and the to-be-replaced virtual item associated with the second target item control is used once. Through aspects of this disclosure, efficiency of human-computer interaction in using an item and marking an item can be improved, so that the efficiency of human-computer interaction can be improved during interaction between virtual objects.

The following describes an example application of this aspect of this disclosure in an actual application scenario.

The terminal runs a client (for example, a network-version gaming application). Gaming interaction with another user is performed through a connection to a game server (namely, the server). At least one first item control is displayed on the terminal. Each first item control is associated with a to-be-picked-up virtual item in the virtual scenario. The terminal transmits, in response to a first trigger operation of a first account on a first target item control, operation data of the first trigger operation to the server. The server obtains display data of an operation result, and returns the display data to the terminal. At least one second item control is displayed on a human-computer interaction interface of the terminal. The first target item control is from the at least one first item control, and each second item control is associated with a to-be-replaced virtual item in an item library of a first virtual object. The terminal transmits, in response to a second trigger operation of the first account on a second target item control, operation data of the second trigger operation to the server. The server obtains display data of an operation result, and returns the display data to the terminal. A to-be-replaced virtual item associated with the second target item control is removed from the item library of the first virtual object, and a to-be-picked-up virtual item associated with the first target item control is added into the item library. The terminal may be a terminal used by a player controlling the first virtual object or a terminal run by an AI program controlling the first virtual object.

The aspects of this disclosure is aimed at quick material replacement. The replaceable material list is triggered and displayed through long pressing on the pickup list. The replaceable material list may include a material identifier, a mark button, a use button, and a progress bar for adjusting a quantity during up and down sliding, to implement a function and transmit information.

Referring to FIG. 5A and FIG. 6A, during interaction of the player in the virtual scenario, when the virtual object 501A controlled by the player is close to the first virtual item, the pickup list 502A is displayed on a main interface. In response to a long press of the player on any control 503A on the pickup list for 0.2 seconds, the material replacement state is entered.

Referring to FIG. 5B, in the material replacement state, the pickup list is hidden, and only the long-pressed control 501B is retained. In addition, a replaceable material list 502B pops up on a right side of the control 501B, and the replaceable material list 502B displays controls 503B of one to three replaceable materials selected by the system and a corresponding quantity.

Referring to FIG. 5C and FIG. 6B, after the player moves up and down more than five pixels in the hot area of the long-pressed control 501C, the progress bar 502C about the pickup quantity may be displayed on the left side of the long-pressed control 501C. A height of the progress bar can be controlled by sliding the screen up and down. A higher height indicates a higher pickup quantity, and a lower height indicates a lower pickup quantity. A quantity of materials for replacement in the replaceable material list 503C on the right side of the long-pressed control 501C is also correspondingly changed.

Referring to FIG. 5D and FIG. 6A, when the finger of the player is moved to a hot area of a control 501D of a replaceable material, a yellow outline appears on the control 501D. If the player releases the finger on the hot area of the control 501D, only a to-be-picked-up material is picked up and a replaceable material is discarded. Still referring to FIG. 5D, FIG. 5E, and FIG. 6C, a type of the replaceable material is determined at a backend. If the type of the replaceable material is medicine or a throwing object, a mark button 502D appears above the control 501D, and a use button 503D appears below the control 501D. If the type of the replaceable material is another type, only a mark button 502E is displayed above a control 501E.

Referring to FIG. 6C, when the finger of the player is moved to the mark button, the mark button is highlighted. After the player releases the finger, a to-be-picked-up material is picked up, and a replaced material is discarded and marked. When the finger of the player is moved to the use button, the use button is highlighted. After the player releases the finger, a to-be-picked-up material is picked up, and a replaced material is used.

A core function of the aspects of this disclosure includes four functions: replacing a material, adjusting a quantity of replacement materials, replacing and marking a material, and replacing and using a material. The four functions are associated with each other and affect each other. However, for ease of understanding, the four functions are to be described separately below. Because triggering of the function is determined based on a difference of hot areas, schematic diagrams of the hot areas are also to be described below.

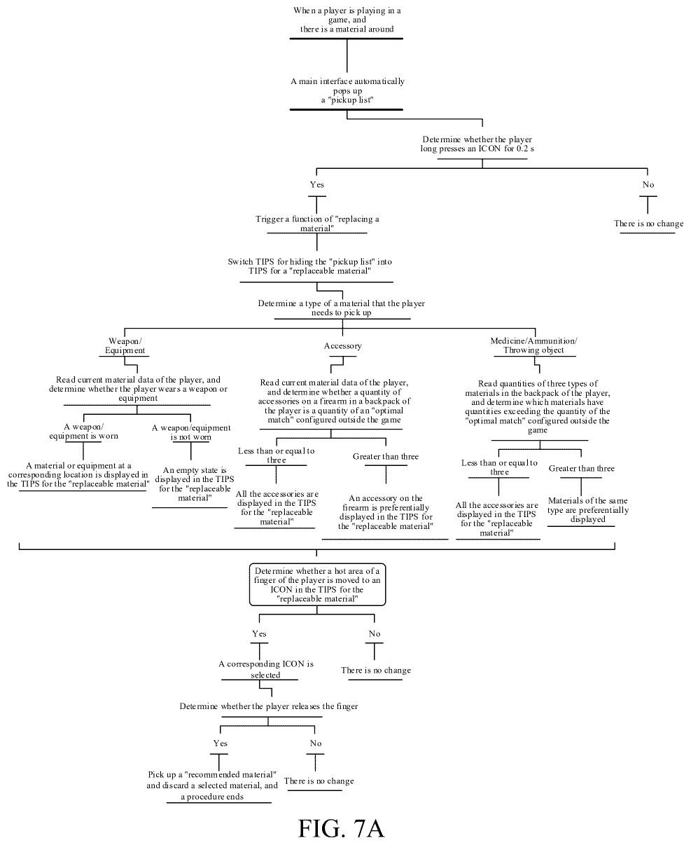

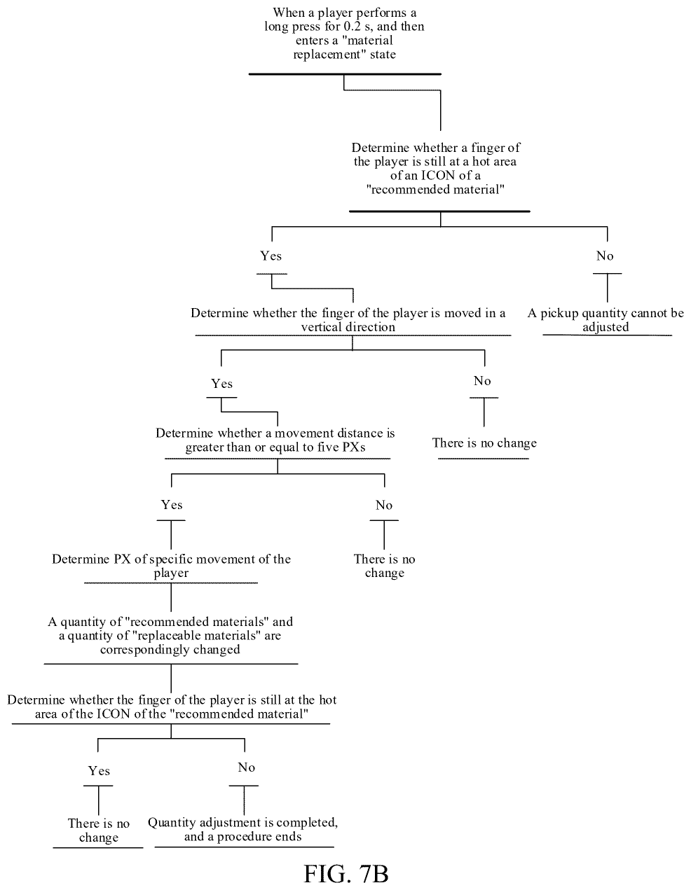

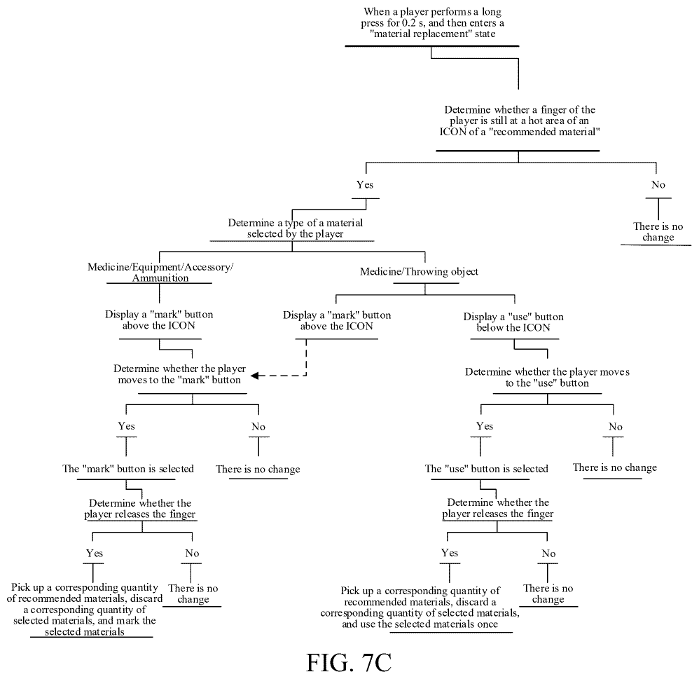

Referring to FIG. 7A, when the player has a material nearby during interaction in the virtual scenario, the main interface automatically pops up the pickup list, and whether the player long presses the control for 0.2 s needs to be determined. If the player does not press the control for 0.2 s, there is no change. If the player presses the control for 0.2 s, the function of replacing the material is triggered. In this case, the pickup list is hidden, a control of a material needed to be picked up is retained on a left side, and a replaceable material is displayed on a right side. In this case, what type of material the player needs to pick up needs to be determined. If the type is attack equipment or equipment, whether the player wears the attack equipment or equipment needs to be read. If the player wears the attack equipment or equipment, attack equipment or equipment at a corresponding location in the replaceable material list is displayed. If the player does not wear the attack equipment or equipment, the replaceable material list is displayed in an empty state. If the type is an accessory, whether a quantity of accessories in a current backpack of the player and a quantity of accessories on a shooting item are a quantity of accessories with an optimal match configured outside the game needs to be read. If the quantity is less than 3, all accessories are displayed in the replaceable material list. If the quantity is not less than 3, the accessories on the shooting item are displayed in the replaceable material list. If the type is ammunition, medicine, or a throwing objects, a quantity of existing items of the three types in the backpack of the player needs to be read, to determine which materials have a quantity exceeding a quantity of the optimal match configured outside the game. If an excess material quantity is less than 3, all materials are displayed in the replaceable material list. If the excess material quantity is not less than 3, materials of the same type are displayed. Whether a hot area of the finger of the player is moved to a control location in the replaceable material list needs to be determined in real time. If the hot area of the finger of the player is not moved to the control location, there is no change. If the hot area of the finger of the player is moved to the control location, a corresponding control is selected. In this case, whether the player releases the finger needs to be determined. If the player does not release the finger, the control remains selected and no change is made. If the player releases the finger, a recommended material is picked up and a selected material is discarded, and an entire procedure ends.

Referring to FIG. 7B, when the player long presses the recommended material for 0.2 s to enter a material replacement state, whether the finger of the player is still in a hot area of a control of the recommended material needs to be determined in real time. If the finger is not in the hot area of the control of the recommended material, the procedure ends. If the finger is in the hot area of the control of the recommended material, whether the finger of the player is moved in a vertical direction needs to be determined. If the finger is not moved in the vertical direction, there is no change. If the finger is moved in the vertical direction, whether a movement distance is greater than or equal to a distance of five pixels needs to be determined. If the movement distance is not greater than or equal to the distance of five pixels, there is no change. If the movement distance is greater than or equal to the distance of five pixels, a specific movement distance of pixels needs to be determined. Then, a quantity of recommended materials and a quantity of replaceable materials are correspondingly changed based on a dragging direction and a dragging distance of the player.

Referring to FIG. 7C, when the player long presses for 0.2 s to enter the material replacement state, whether the finger of the player is moved to the hot area of the control in the replaceable material list needs to be determined. If the finger is not moved to the hot area, there is no change. If the finger is moved to the hot area, a type of a replaceable material selected by the player needs to be further determined. If the replaceable material is attack equipment, equipment, an accessory, or ammunition, the mark button is displayed above the selected control. If the replaceable material is medicine or a throwing object, the mark button is displayed above the selected control, and the use button is displayed below the selected control. In this case, whether the player moves to the mark button needs to be determined. If the player does not move to the mark button, there is no change. If the player moves to the mark button, the mark button is selected, and whether the player releases the finger needs to be determined again. If the player does not release the finger, there is no change. If the player releases the finger, a corresponding quantity of recommended materials are picked up, a corresponding quantity of selected materials are discarded, and the selected materials are automatically marked. In this case, whether the player moves to the use button needs to be determined. If the player does not move to the use button, there is no change. If the player moves to the use button, the use button is selected, and whether the player releases the finger needs to be determined again. If the player does not release the finger, there is no change. If the player releases the finger, a corresponding quantity of recommended materials are picked up, a quantity of selected materials are discarded, and the selected material is used once.

In the aspects of this disclosure, a core function of replacement is added to a pickup procedure. In addition, there is an auxiliary addition of three peripheral functions: adjusting a pickup quantity, marking a discarded material, and using a discarded material. This allows the player to easily perform a replace operation on a material that the player expects to pick up during a pickup process. The player can also smoothly deal with a recommended material encountered when the backpack is full. In addition, through the functions of marking a discarded material and using a discarded material, a useless material can be well reused. This promotes team communication within a team and facilitates management of a backpack capacity and material configuration by the player, allowing the player to focus more on a battle. In addition, the entire system only requires the players to long press and slide to interact, and the entire procedure only requires one operation, greatly improving the efficiency of human-computer interaction.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The following continues to describe an example structure of an item processing apparatus 455 in a virtual scenario implemented as a software module according to an aspect of this disclosure. In some aspects, as shown in FIG. 3, a software module that is in the item processing apparatus 455 in a virtual scenario and that is stored in a memory 450 may include: a display module 4551, configured to display at least one first item control, each first item control being associated with a to-be-picked-up virtual item in the virtual scenario; a first trigger module 4552, configured to display at least one second item control in response to a first trigger operation of a first account on a first target item control, the first account being an account controlling a first virtual object, the first target item control being from the at least one first item control, and each second item control being associated with a to-be-replaced virtual item in an item library of the first virtual object; and a second trigger module 4553, configured to: remove, in response to a second trigger operation of the first account on a second target item control, a to-be-replaced virtual item associated with the second target item control from the item library of the first virtual object, and add a to-be-picked-up virtual item associated with the first target item control into the item library, the second target item control being from the at least one second item control.

In some aspects, the display module 4551 is further configured to: display, when a first distance between the first virtual object and the to-be-picked-up virtual item is less than a first distance threshold, a first item control associated with the to-be-picked-up virtual item.

In some aspects, when a plurality of first item controls exist, the first trigger module 4552 is further configured to: when displaying the at least one second item control, hide a first item control other than the first target item control in the plurality of displayed first item controls.

In some aspects, the first trigger module 4552 is further configured to: display the at least one second item control when the first trigger operation is any trigger operation and a capacity occupied by all virtual items of the first virtual object exceeds a capacity threshold; or display the at least one second item control when operation attribute data of the first trigger operation satisfies a trigger condition of item replacement logic.

In some aspects, the first trigger module 4552 is further configured to: display a second item control corresponding to a target item type, the target item type being an item type corresponding to the first target item control; or display, when a configuration quantity of candidate virtual items in the item library of the first virtual object exceeds a maximum configuration quantity, a second item control corresponding to the candidate virtual item, the maximum configuration quantity being a maximum holding quantity of each type of virtual item in a target item configuration of the item library.

In some aspects, the first trigger module 4552 is further configured to: display the second item control corresponding to the target item type when the target item type is an attack item type and the first virtual object has been equipped with a virtual item of the target item type.

In some aspects, the first trigger module 4552 is further configured to: display, when the target item type is an accessory item type and a quantity of virtual items belonging to the accessory item type in the item library is less than a first quantity threshold, second item controls corresponding to all virtual items belonging to the accessory item type; and display, when the target item type is the accessory item type and the quantity of virtual items belonging to the accessory item type in the item library is not less than the first quantity threshold, a second item control corresponding to a virtual item that belongs to the accessory item type and that is related with equipment of the first virtual object.

In some aspects, the first trigger module 4552 is further configured to: display, when the target item type is an item type in another item type and a quantity of virtual items belonging to the another item type in the item library is less than a second quantity threshold, second item controls corresponding to all virtual items belonging to the another item type; and display, when the target item type is the another item type and the quantity of virtual items belonging to the another item type in the item library is not less than the second quantity threshold, a second item control corresponding to a virtual item belonging to the target item type, the another item type being an item type other than an attack item type and an accessory item type.

In some aspects, the first trigger operation is a continuous operation on a target connection button, and the first trigger module 4552 is further configured to: display a progress bar of the first target item control when retention time of the first trigger operation exceeds a first operation data threshold, a progress value of the progress bar representing a pickup quantity of to-be-picked-up virtual items corresponding to the first target item control; and display a progress value matching an operation attribute of the first trigger operation and operation data of the operation attribute in the progress bar.

In some aspects, the first trigger module 4552 is further configured to: display an identifier of the to-be-replaced virtual item associated with each second item control, and display a quantity of to-be-replaced virtual items associated with each second item control in the item library; and update, when displaying the progress value matching the operation attribute of the first trigger operation and the operation data of the operation attribute in the progress bar, based on the progress value, the displayed quantity of to-be-replaced virtual items associated with each second item control in the item library.

In some aspects, after the at least one second item control is displayed, the first trigger module 4552 is further configured to: perform the following processing when the first trigger operation is a continuous operation and is not released during the displaying of the second item control: generating a movement track in response to the continuous operation, and displaying the second target item control in a selected state when a contact point of the continuous operation is moved to a sensing area corresponding to the second target item control; and identifying, when the continuous operation is released, the releasing of the continuous operation as the second trigger operation on the second target item control.

In some aspects, after the second target item control is displayed in the selected state, the first trigger module 4552 is further configured to: display a use control and a mark control at corresponding locations of the second target item control when the to-be-replaced virtual item associated with the second target item control is a markable and usable item; or display a mark control at a corresponding location of the second target item control when the to-be-replaced virtual item associated with the second target item control is a markable and unusable item.

In some aspects, the first trigger module 4552 is further configured to: identify, when the contact point of the continuous operation is moved to the mark control, releasing of the continuous operation at the mark control as the second trigger operation on the second target item control, and mark the to-be-replaced virtual item associated with the second target item control, to prompt a second virtual object located in a same group as the first virtual object to pick up the marked virtual item; or identify, when the contact point of the continuous operation is moved to the use control, releasing of the continuous operation at the use control as the second trigger operation on the second target item control, and display a process in which the first virtual object uses the to-be-replaced virtual item associated with the second target item control.

An aspect of this disclosure provides a computer program product, including computer-executable instructions, the computer-executable instructions being stored in a computer-readable storage medium. A processor of an electronic device reads the computer-executable instructions from the computer-readable storage medium, and executes the computer-executable instructions, to cause the electronic device to perform the foregoing item processing method in a virtual scenario according to the aspects of this disclosure.

An aspect of this disclosure provides a computer-readable storage medium, such as a non-transitory computer-readable storage medium having computer-executable instructions stored therein, the computer-executable instructions, when executed by a processor, causing the processor to perform the item processing method in a virtual scenario according to the aspects of this disclosure. For example, the item processing method in a virtual scenario shown in FIG. 4A to FIG. 4C.

In some aspects, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some aspects, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, through the aspects of this disclosure, the first target item control is displayed, and the first target item control is associated with the to-be-picked-up virtual item. In response to the first trigger operation on the first target item control, the second item control is displayed. The second item control is associated with the to-be-replaced virtual item in the item library of the first virtual object. This is equivalent to that a control of an item for replacement can be presented through triggering of a control of a to-be-picked-up item, reducing an interaction operation of opening the item library. In response to the second trigger operation on the second target item control, the to-be-replaced virtual item in the item library is replaced with the to-be-picked-up virtual item. This is equivalent to that an operation of picking up a new item and an operation of discarding an old item are completed together, further reducing an interaction procedure and improving overall efficiency of human-computer interaction.

The foregoing descriptions are merely some aspects of this disclosure and are not intended to limit the scope of this disclosure. Any modification, equivalent replacement, or improvement made without departing from the spirit and range of this disclosure shall fall within the scope of this disclosure.

What is claimed is:

1. A method for processing items in a virtual scene, the method comprising:
outputting for display at least one first item control element, each of the at least one first item control element being associated with a pickable virtual item in the virtual scene;
outputting for display at least one second item control element based on a first trigger operation being performed on a first target item control element of the at least one first item control element, each of the at least one second item control element being associated with a replaceable virtual item in an inventory of a first virtual object; and
based on a second trigger operation being performed on a second target item control element of the at least one second item control element,
removing the replaceable virtual item associated with the second target item control element from the inventory of the first virtual object, and
adding the pickable virtual item associated with the first target item control element to the inventory.

2. The method according to claim 1, wherein the outputting for display the at least one first item control element comprises:
outputting for display the first target item control element associated with the pickable virtual item when a first distance between the first virtual object and the pickable virtual item is less than a first distance threshold.

3. The method according to claim 1, wherein
when the at least one first item control element includes a plurality of first item control elements and the at least one second item control element is output for display, at least one of the plurality of first item control elements that is different from the first target item control element is not output for display.

4. The method according to claim 1, wherein the outputting for display the at least one second item control element comprises:
outputting for display the at least one second item control element when a number of virtual items in the inventory is greater than or equal to a capacity threshold.

5. The method according to claim 1, wherein the outputting for display the at least one second item control element comprises:
outputting for display the at least one second item control element when the first trigger operation is a predetermined gesture.

6. The method according to claim 1, wherein the outputting for display the at least one second item control element comprises at least one of:
outputting for display a second item control element corresponding to a target item type, the target item type corresponding to an item type of the first target item control element.

7. The method according to claim 6, wherein the outputting for display the second item control element corresponding to the target item type comprises:
outputting for display the second item control element when the target item type is an attack item type, and the first virtual object is equipped a virtual item of the attack item type.

8. The method according to claim 6, wherein the outputting for display the second item control element corresponding to the target item type comprises:
outputting for display a plurality of second item control elements corresponding to virtual items of an accessory item type when the target item type is the accessory item type and a quantity of virtual items belonging to the accessory item type in the inventory is less than a first quantity threshold; and
outputting for display a second item control element corresponding to a virtual item of the accessory item type and relates to equipment of the first virtual object when the target item type is the accessory item type and the quantity of virtual items belonging to the accessory item type in the inventory is greater than or equal to the first quantity threshold.

9. The method according to claim 6, wherein the outputting for display the second item control element corresponding to the target item type comprises:
outputting for display a plurality of second item control elements corresponding to virtual items of an additional item type when the target item type is the additional item type and a quantity of virtual items belonging to the additional item type in the inventory is less than a second quantity threshold; and
outputting for display a second item control element corresponding to a virtual item of the target item type when the target item type is the additional item type and the quantity of virtual items associated with the additional item type in the inventory is greater than or equal to the second quantity threshold,
the additional item type being different from an attack item type and an accessory item type.

10. The method according to claim 1, wherein the first trigger operation is a continuous operation, and the method further comprises:
outputting for display a progress bar of the first target item control element when a retention time of the first trigger operation exceeds a first time threshold, a progress value of the progress bar changing according to a pickup quantity of the pickable virtual item associated with the first target item control element.

11. The method according to claim 10, further comprising:
outputting for display a quantity of replaceable virtual items associated with each of the at least one second item control element in the inventory; and
updating the displayed quantity of replaceable virtual items associated with each of the at least one second item control element based on the progress value.

12. The method according to claim 1, further comprising:
when the first trigger operation is a continuous operation that is not released during the outputting of the at least one second item control element,
generating a movement trajectory based on the continuous operation;
outputting for display the second target item control element in a selected state when a contact point of the continuous operation moves to a sensing area corresponding to the second target item control element; and
identifying release of the continuous operation as the second trigger operation on the second target item control element.

13. The method according to claim 12, further comprising:
outputting for display at least one of a use item control element and a mark location control element at corresponding locations of the second target item control element.

14. The method according to claim 13, further comprising:
when the contact point of the continuous operation moves to the mark location control element,
identifying release of the continuous operation at the mark location control element as the second trigger operation on the second target item control element, and
marking the replaceable virtual item associated with the second target item control element to indicate a discard location; and
when the contact point of the continuous operation moves to the use item control element,
identifying release of the continuous operation at the use control element as the second trigger operation on the second target item control element, and
causing the first virtual object to use the replaceable virtual item associated with the second target item control element.

15. An apparatus for processing items in a virtual scene, the apparatus comprising:
processing circuitry configured to:
output for display at least one first item control element, each of the at least one first item control element being associated with a pickable virtual item in the virtual scene;
output for display at least one second item control element based on a first trigger operation being performed on a first target item control element of the at least one first item control element, each of the at least one second item control element being associated with a replaceable virtual item in an inventory of a first virtual object; and
based on a second trigger operation being performed on a second target item control element of the at least one second item control element,
remove the replaceable virtual item associated with the second target item control element from the inventory of the first virtual object, and
add the pickable virtual item associated with the first target item control element to the inventory.

16. The apparatus according to claim 15, wherein the processing circuitry is configured to:
output for display the first target item control element associated with the pickable virtual item when a first distance between the first virtual object and the pickable virtual item is less than a first distance threshold.

17. The apparatus according to claim 15, wherein
when the at least one first item control element includes a plurality of first item control elements and the at least one second item control element is output for display, at least one of the plurality of first item control elements that is different from the first target item control element is not output for display.

18. The apparatus according to claim 15, wherein the processing circuitry is configured to:
output for display the at least one second item control element when a number of virtual items in the inventory is greater than or equal to a capacity threshold.

19. The apparatus according to claim 15, wherein the processing circuitry is configured to:
output for display the at least one second item control element when the first trigger operation is a predetermined gesture.

20. A non-transitory computer-readable storage medium storing instructions which, when executed by a processor, cause the processor to perform:
outputting for display at least one first item control element, each of the at least one first item control element being associated with a pickable virtual item in a virtual scene;
outputting for display at least one second item control element based on a first trigger operation being performed on a first target item control element of the at least one first item control element, each of the at least one second item control element being associated with a replaceable virtual item in an inventory of a first virtual object; and
based on a second trigger operation being performed on a second target item control element of the at least one second item control element,
removing the replaceable virtual item associated with the second target item control element from the inventory of the first virtual object, and
adding the pickable virtual item associated with the first target item control element to the inventory.
